(19) United States
(12) Patent Application Publication
(10) Pub. No.: US 2026/0184100 A1
(43) Pub. Date: Jul. 2, 2026

(54) METHOD FOR TRANSFERRING A SECURITY ELEMENT ONTO A TARGET SUBSTRATE

(71) Applicant: GIESECKE+DEVRIENT CURRENCY TECHNOLOGY GMBH, Munchen (DE)

(72) Inventors: Josef SCHINABECK, Kreuth (DE); Bjorn TEUFEL, Weissach (DE)

(21) Appl. No.: 18/856,235

(22) PCT Filed: Apr. 20, 2023
(86) PCT No.: PCT/EP2023/025182

§ 371 Date: Oct. 11, 2024

(30) Foreign Application Priority Data
Apr. 25, 2022 (DE) 10 2022 001 402.5

(51) Int. Cl. B42D 25/351; B42D 25/373; B42D 25/47

(52) U.S. Cl. CPC B42D 25/351; B42D 25/373; B42D 25/47

(57) ABSTRACT

A method for transferring a security element onto a target substrate, includes: providing the security element; applying the security element onto the target substrate; irradiating a radiation-curable adhesive layer from the security element side to cure the radiation-curable adhesive layer, as a result of which the security element is permanently bonded to the target substrate, wherein the security element is opaque to the irradiation in an effect region and transparent to the irradiation in at least one transparency element. For the irradiation from the security element side, a plurality of transparency elements are arranged distributed in the security element so that a plurality of cured partial areas of the adhesive layer are created during the irradiation through the transparency elements, these partial areas being separated from one another by an uncured partial area of the adhesive layer. The plurality of transparency elements comprise a plurality of transparent raster elements.

### BACKGROUND

The invention relates to a method for transferring a security element, in particular from a transfer carrier, onto a target substrate, wherein a radiation-curable adhesive layer is cured, and to a corresponding target substrate having a security element.

It is known to apply security elements, which are provided on a transfer carrier, onto a target substrate, and to release them from the transfer carrier, in a transfer apparatus. The security element is generally fastened on the target substrate by means of an adhesive layer.

WO 2010/031543 A1 describes a transfer carrier having security elements. WO 2016/188624 A1 relates to an apparatus for transferring security elements onto a target substrate.

It is likewise already known that an adhesive layer which can be cured with UV light may be used during the transfer, irradiation of the adhesive layer for the curing taking place after the application onto the target substrate but in particular already before the release of the transfer carrier. If the irradiation takes place through the transfer carrier, it has been found to be disadvantageous that the security elements are not always equally UV-transparent to the UV light and that irradiation is in general additionally necessary from the other side.

WO 2009/127325 A1 relates to a method for protecting a document of value, which has an applied security element, by weakening lines and markings being introduced into the security element by means of a laser.

### SUMMARY

The object of the invention is to provide a reliable method for transferring security elements, which can preferably be used flexibly and at the same time provides a high level of forgery protection, in particular protection for the target substrate with an applied security element.

A method for transferring a security element onto a target substrate comprises the following steps:
providing the security element;
applying the security element onto the target substrate;
irradiating a radiation-curable adhesive layer from the security element side in order to cure the radiation-curable adhesive layer, as a result of which the security element is permanently bonded to the target substrate,
wherein the security element is opaque to the irradiation in an effect region and is transparent to the irradiation in at least one transparency element.

In the security element, a plurality of transparency elements are arranged distributed for the irradiation from the security element side, in such a way that a plurality of cured partial areas of the adhesive layer are created during the irradiation through the transparency elements, these partial areas being separated from one another by at least one uncured partial area of the adhesive layer. The plurality of transparency elements comprises a plurality of transparent raster elements.

The irradiated and thereby cured adhesive area permanently bonds the security element to the target substrate. Since a plurality of cured partial areas (or portions) of the adhesive layer are created, the bonding is ensured by the plurality of partial areas. In particular, the arrangement (consisting of the target substrate and the security element) as a whole is at the same time secured by each individual bond against manipulation. In the event of an attempt to separate the security element from the target substrate again, the target substrate and/or the security element will be destroyed.

In some embodiments, the plurality of transparency elements comprises in addition a plurality of transparency regions. The transparency regions, which are transparent to the irradiation, are respectively surrounded by the effect region which is opaque to the irradiation.

Correspondingly, the partial areas of the adhesive layer that are cured through the transparency regions are respectively surrounded by an/the uncured partial area of the adhesive layer.

The plurality of transparency elements comprises a plurality of transparent raster elements. Optionally, there may supplementarily be one or more (in particular a few, for instance from two to five) transparency regions in the distribution. The raster elements (and transparency regions), which are transparent to the irradiation, are respectively surrounded by the effect region which is opaque to the irradiation. The partial areas of the adhesive layer that are cured through the transparent raster elements (and transparency regions) are respectively surrounded by an/the uncured partial area of the adhesive layer.

The plurality of transparency elements may optionally comprise a transparent marginal region of the security element. The marginal region is transparent both to visible light and to the irradiation, which is preferably UV light. The marginal region delimits a central region generally on at least two sides, and preferably surrounds it. When there is a marginal region, the security element preferentially comprises the marginal region and a central region, which is formed by the effect region and by the raster elements and/or transparency regions that are surrounded by the effect region (which are then also referred to as inner regions).

The plurality of transparency regions and/or of raster elements may be arranged regularly distributed, particularly in a (two-dimensionally) periodic raster. Alternatively, the transparency regions and/or the raster elements are arranged irregularly (or aperiodically) distributed. The distribution over the area then appears random or quasi-random, but may also be perceptible as a deliberate extensive but irregular distribution. The raster elements are provided in a plurality of more than 6, preferably more than 10, more preferentially more than 15. The transparency regions are provided in a plurality of more than 4, preferably more than 8, more preferentially more than 12. The plurality of transparency elements correspondingly additionally comprises the optional one or two marginal regions and, in the case of raster elements, the few optional, two to five transparency regions.

The shape of the transparency regions is preferably perceptible for an observer of the security element when viewed directly and/or when viewed in transmission. There may in particular be transparency regions either with a uniform (first) shape or with a first shape and at least one second shape in the security element. The shape of the transparency regions may for example be a symbol, a sign, a numeral or a geometrical element such as a circle or an n-gon.

There could thus for example be a plurality of transparency regions with a first, in particular geometrical shape such as a circle, strip or star, which are arranged distributed where there is or are no transparency region(s) with (a) second shape(s), in particular different numerals, letters and/or symbols.

The raster elements are however not perceptible for the observer when viewed directly and/or are visible without their shape being perceptible for the observer when viewed in transmission. The optically variable effect of the effect region for the observer is thus not influenced by the distributedly arranged raster elements.

The radiation-curable adhesive layer may be a UV-curing adhesive layer. The irradiation takes place by means of UV light, preferably UV-A light.

The security element may be provided on a transfer carrier. The transfer carrier is released from the security element applied onto the target substrate. Preferably, the irradiation from the security element side takes place before the release step and through the transfer carrier. The transfer carrier will generally comprise a multiplicity of security elements, which in particular are separated from one another and are preferably arranged successively in the transport direction and/or next to one another on the transfer carrier.

The security element may, for example, be a patch or a strip. As is known, patches lie locally inside an individual item, such as a banknote, of the target substrate. Strips, on the other hand, extend at least from one margin to the other of an individual item, such as a banknote, of the target substrate. The target substrate may be in the form of a sheet or web.

The security element is an optically variable security element, preferably having a reflective optically variable security feature. The security element is, in particular, optically variable as a function of the observation angle. For example, it shows different colors, motifs or views of a motif as a function of the observation angle. The security element may comprise one or more relief layers, for example having reflective or refractive elements such as microlenses, microrefractors or micromirrors. In principle, the security element may contain security features that are machine-readable and/or intended for the observer, or combinations of such security features (diffractive, refractive, luminescent, magnetic, etc.).

Merely for the sake of completeness, it will be mentioned that insofar as an observer or observation is referred to here, a normal observation situation is assumed. The observation distance is for example approximately between 20 and 40 cm. The observer does not use any technical aids, i.e. they observe with the naked eye.

The effect layer, which is opaque to the irradiation, preferably is or comprises a reflecting metal layer and/or an ink layer, which may in particular be arranged on an embossed relief layer.

The area of the adhesive layer generally corresponds to the area of the effect region together with the area of the transparency elements, that is to say, for example, together with the areas of the raster elements, together with the marginal region and the raster elements as well as the optional inner region(s), together with the areas of the inner regions or together with the marginal region and the inner regions. It is, however, known that the area of the adhesive layer may also be smaller than the base area of the security element (not reaching as far as the boundary of the security element in the marginal region).

It is preferably assumed here that the maximum size of the raster elements is less than 300 μm (in both directions, length and width), preferably between 10 μm and 250 μm, further preferentially between 20 μm and 150 μm. The minimum size of the transparency (or inner) regions is more than 300 μm in one direction, preferentially more than 300 μm in two directions (such as length and width).

The adhesive layer may have an irradiation area (or cured partial areas) which consists at least of a plurality of raster-element irradiation areas or a plurality of transparency-region (or inner-region) irradiation areas. Optionally, it further consists of a marginal irradiation area and/or, in the case of a plurality of raster-element irradiation areas, of one or a few (two to five) transparency-region (or inner-region) irradiation area(s).

The radiation-curable adhesive layer may be provided as a layer of the security element. Alternatively, it is provided with the target substrate or is applied in the transfer apparatus onto the target substrate or the security element, in particular regionally printed onto the target substrate.

A region or a layer is opaque to the curing irradiation in the present sense beyond an opacity of 85%, preferentially 95%, to the curing irradiation. A region, an element or a layer is transparent to the curing irradiation in the present sense beyond a transparency of more than 65%, preferably more than 80%, more preferentially more than 90%, to the curing irradiation.

Overall, preferably at least 40%, in particular between 40% and 80%, of the area of the adhesive layer of the security element is cured. Advantageously, between 10% and 50%, preferably from 10% to 25%, of the area of the adhesive layer may be cured in an area in which only raster elements and the surrounding effect region lie. Overall, from 40% to 66% of the area of the adhesive layer of the security element could in this case be cured. Advantageously, on average between 25% and 66%, preferably from 30% to 60%, of the area of the adhesive layer may be cured in an area in which transparency regions and the surrounding effect region lie. Overall, from 50% to 80% of the area of the adhesive layer of the security element could then be cured.

The radiation-curable adhesive layer may be an adhesive layer that is cured by UV light, particularly in the UV-A range, or by shortwave light, in particular <450 nm. It may furthermore be a thermally activatable, radiation-curable adhesive layer, in particular a hot-melt adhesive layer, preferentially a UV-curing hot-melt adhesive layer.

A transfer carrier having security elements is provided, wherein the security elements are arranged releasably on the transfer carrier and, for transfer onto a target substrate, in particular by one of the methods described so far, or in the sense of the embodiments so far, comprise an adhesive layer which can be cured with curing radiation. The transfer carrier is transparent to the curing radiation. The security elements respectively have an effect region which is opaque to the curing radiation and at least one transparency element which is transparent to the curing radiation. Now, for irradiation from the security element side with the curing radiation, a plurality of transparency elements are respectively arranged distributed in the security elements in such a way that a plurality of cured partial areas of the adhesive layer are created during the irradiation through the transparency elements, these partial areas being separated from one another by at least one uncured partial area of the adhesive layer. The plurality of transparency elements comprises a plurality of transparent raster elements.

A system for carrying out, for example, one of the described methods comprises such a transfer carrier and a transfer apparatus. The transfer apparatus comprises in particular an application unit (for applying the security element onto the target substrate), an irradiation unit and a releasing unit (for releasing the transfer carrier from the security element applied onto the target substrate).

A plurality of security elements are arranged on the transfer carrier. The security elements may be arranged successively in the transport direction and/or arranged separated from one another and preferably spaced apart from one another and/or may be in the form of a patch or strip, respectively with or without their own carrier layer.

A target substrate having a security element may be provided, wherein the security element is fastened on the target substrate by means of an adhesive layer,
wherein the adhesive layer is formed from radiation-curable material and comprises at least one cured portion and one uncured portion,
wherein the security element has an effect region which is opaque to curing radiation of the radiation-curable material and at least one transparency element which is transparent to the curing radiation.

A plurality of transparency elements, which respectively lie over a cured portion of the adhesive layer, are arranged in the security element. The cured portions of the adhesive layer are separated from one another by at least one uncured portion of the adhesive layer. The plurality of transparency elements comprises a plurality of transparent raster elements.

The arrangement consisting of the target substrate and the security element may be produced by one of the methods described above and may correspondingly have the partial features or properties already mentioned above for the target substrate and/or the security element and/or the adhesive layer.

It is to be understood that the features mentioned above and those yet to be explained below may be used not only in the combinations indicated but also in other combinations without departing from the scope of the present invention, insofar as this is included by the protective scope of the claims.

### BRIEF DESCRIPTION OF THE DRAWINGS

Some further advantages of the invention will be explained with the aid of the following exemplary embodiments and the appended figures. For the sake of better understanding, the representations in the figures are highly schematized and, in particular, the proportions shown in the figures do not correspond to the relationships actually existing and therefore serve primarily to improve clarity.

In detail:

FIG. 1 schematically shows an apparatus for transferring a security element onto a target substrate, having an irradiation unit

FIG. 2 schematically shows a security element having an effect region, a plurality of inner regions that are transparent to the irradiation, and a transparent marginal region,

FIG. 3 schematically shows a security element having an effect region, a plurality of raster elements that are transparent to the irradiation, and a transparent marginal region,

FIG. 4 schematically shows a security element on a transfer carrier and

FIG. 5 schematically shows examples of partial layers of a security element on a transfer carrier.

### DETAILED DESCRIPTION OF VARIOUS EMBODIMENTS

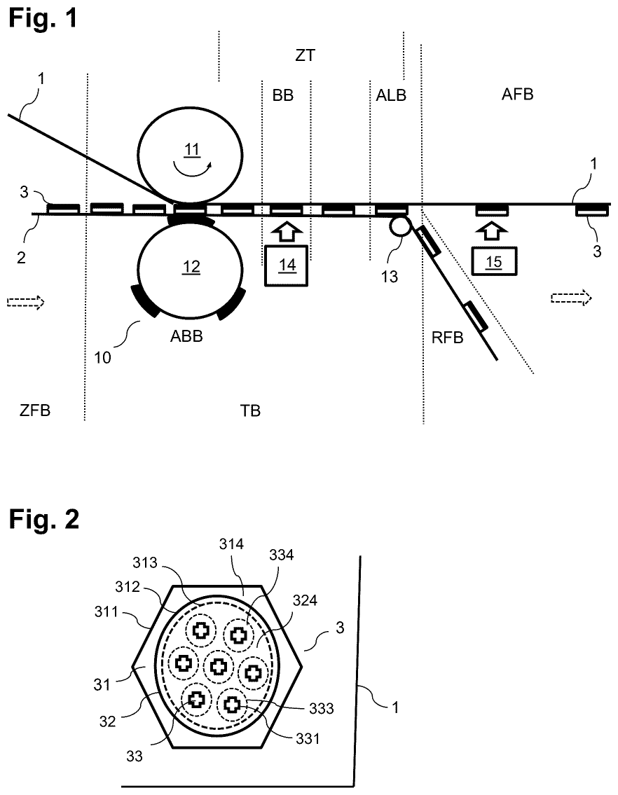

FIG. 1 shows an apparatus 10 for transferring security elements 3 onto a target substrate 1. The apparatus 10 comprises an application unit 11, 12, a releasing unit 13 and at least one irradiation unit 14, 15. Not represented in the figure are, for example, transport devices which transport the target substrate and/or carrier substrate in the apparatus. The basic transport direction in the apparatus 10 is-on the right and left in the figure-indicated by two dashed arrows (from left to right).

The target substrate 1 and a transfer carrier 2 with the security elements 3 arranged releasably on the transfer carrier 2 are provided in a supply region ZFB of the apparatus 10. The security elements 3 comprise a UV-curable (hot-melt) adhesive layer. The adhesive layer bonds the security elements 3 to the target substrate 1 and needs to be cured with UV light in order to ensure a durable bond with the target substrate 1. The adhesive layer may alternatively, preferably in the transfer apparatus, be applied onto the security elements 3 and/or regionally onto the target substrate 1. The adhesive layer may in addition be created from two partial layers, which for example do not come in contact until during the application.

The application unit 11, 12 (in the application region ABB) comprises in the example shown a preferably heated, structured stamp roll 12 and a counterpressure roll 11. The stamp roll is configured so that every second security element 3 of the plurality of security elements 3 arranged successively on the transfer carrier 2 is applied onto the target substrate 1. The application takes place by means of pressure (and heat). Other types of application units (for example unstructured rollers, linear stamps, or units in the sense of WO 2016/188624 A1) may be envisioned and are sufficiently known.

The irradiation unit 14 is arranged between the application unit 11, 12 and the releasing unit 13 (irradiation region BB). It comprises at least one UV radiator, which in particular is a UV LED radiator. The irradiation can selectively be provided or not provided, for example with the aid of a controller which turns the radiator or radiators on and off or masks and unmasks it/them (manual stop/shutter, etc.). The or each applied security element 3 is irradiated by the first irradiation unit 14 (and/or the second irradiation unit 15). Optionally possible security elements 3 that are not applied by the application unit 10, 11 are not, however, irradiated. The wavelength of the irradiation lies in the UV-A range (>315 nm). Alternatively to this irradiation, irradiation may also take place in the shortwave visible range (wavelength <450 nm) when a correspondingly curable adhesive layer is used.

The UV irradiation unit 14 irradiates the adhesive layer of the security element 3 through the UV-transparent transfer carrier 2 and through the security element 3, or the further partial layers of the security element 3. The adhesive layer is irradiated from the security element side. In particular, an effect layer, for example a metallization or an ink layer, of the security element may however be opaque to UV radiation.

The releasing unit 13 (in the release region ABB) is represented as a roller but may also be configured in another way, for example as an edge. The transfer carrier 2, in the example together with the non-applied (and correspondingly non-irradiated) security elements 3, is released from the applied security element 3. The release of the security elements may be assisted in a known manner by means of a release layer (not represented, in the layer structure of the security element or of the transfer carrier).

The transfer carrier 2 is guided out of the apparatus in a recycling region RFB and may again be used/provided/recycled. The transfer carrier 2 without security elements could be reused by applying new security elements. The transfer carrier 3 with remaining security elements may be reused by providing it again for the apparatus 10 or another apparatus. The remaining security elements, every second or every nth security element, are later transferred onto an (optionally different) target substrate.

A second irradiation unit 15 may alternatively or optionally be provided, which irradiates the adhesive layer likewise from the security element side. For example, the second irradiation unit 15 may cure the adhesive layer on its own or it may post-cure the adhesive layer. The UV irradiation unit 15 irradiates the adhesive layer of the security element 3 through the security element 3, or the further partial layers of the security element 3.

The transfer apparatus 10 according to FIG. 1 may be assumed to be substantially already known. It is likewise known to configure a transfer alternatively without the release from the transfer carrier as shown after the application, for example by release before the application, by stamping out the security element or even without a transfer carrier.

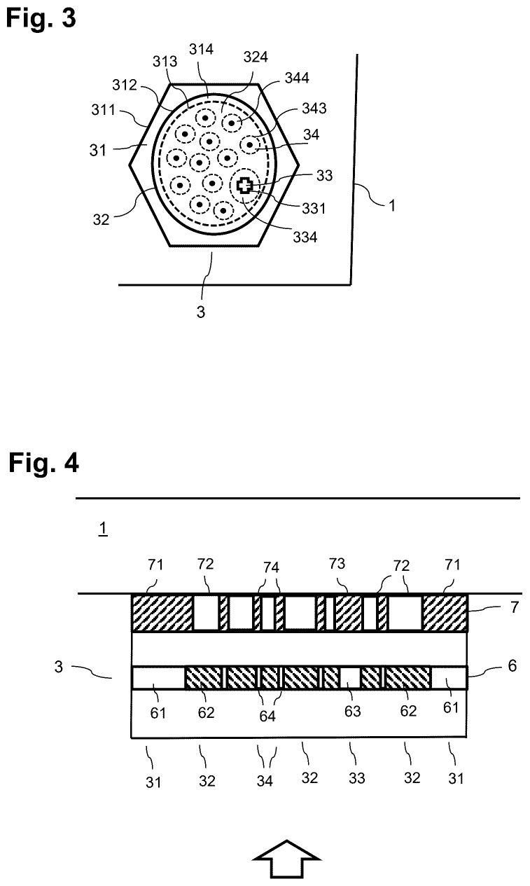

Possible optimized embodiments of security elements will be presented with the aid of the following FIGS. 2 and 3.

FIG. 1 shows a cross section through the transfer apparatus 10. In FIGS. 2 and 3, on the other hand, a representation of the security element 3 on the target substrate 1 in a plan view is chosen in order to make the regions or areas of the security element 3 more clearly perceptible.

FIG. 2 shows a security element 3 which could optionally still be arranged on the transfer carrier (not represented) and is already applied onto the target substrate 1.

The security element 3 comprises a central region 32, 33 and a transparent marginal region 31.

The transparent marginal region 31 is transparent at least to the curing UV irradiation, and preferably is also transparent to visible light. The UV irradiation is absorbed only in the radiation-curable adhesive layer of the security element. An outer boundary of the security element 3 is at the same time the outer boundary 311 of the marginal region. The marginal region 31 reaches from its outer boundary 311 to its inner boundary 312, which at the same time forms the outer boundary of the central region 12, 13.

The central region 32, 33 comprises a UV-opaque effect region 32 and a plurality of UV-transparent inner regions 33.

In the effect region 32, the security element is entirely opaque (>95% opacity) or opaque (>85% opacity) to UV light. The effect region 32 of the security element provides an optically variable security feature for the observer, that is to say in particular an observation angle-dependently and/or reflectively optically variable security feature. In the effect region 32, there is preferably a UV-opaque ink layer and/or a UV-opaque metal layer.

The inner regions 33 in the central region 32, 33 are UV-transparent. For example, there may be recesses in the UV-opaque ink layer and/or the UV-opaque metallization. The inner regions 33 respectively have a shape that is perceptible for the observer when viewed in transmission (and optionally also when viewed directly), for example a cross, circle, n-gon or sign. The visible shapes of the inner regions 33 may be different (various symbols or numerals) or uniform, as represented. Each inner region 33 has an outer boundary 331. The UV-transparent inner regions 33 are surrounded by the UV-opaque effect region 32. An outer boundary 331 of the inner region 33 is thus at the same time an inner boundary of the effect region 32.

If the security element 3 with its adhesive layer is UV-irradiated from the security element side, for example irradiated through the transfer carrier 2, the irradiation passes through the transparent marginal region 31 and through the UV-transparent inner regions to the adhesive layer. The adhesive layer is cured in the irradiated areas 314, 334. In the non-irradiated area(s) 324, the adhesive layer is not cured. Through the marginal region 31, the UV light passes onto the underlying portion of the adhesive layer and partially also into an adjacent portion of the adhesive layer, which lies below the effect region 32. The marginal irradiation area 314 irradiated through the marginal region begins at the outer boundary 311 of the marginal region 31 and ends at its inner boundary 313. Through the inner region 33, the UV light passes on the one hand onto the underlying portion of the adhesive layer, but also into an adjacent portion of the adhesive layer, which lies below the effect region 32. The inner-region irradiation area 334 irradiated through the inner regions 33 is delimited by its outer boundary 333.

The inner regions 33 are now arranged distributed over the security element 3, or over the central region 32, 33 of the security element 3, so that, during the irradiation through the transparency elements 33, a corresponding plurality of cured partial areas or inner-region irradiation areas 334 of the adhesive layer are created, these being separated from one another by the-in the example precisely one-uncured partial area 324 of the adhesive layer. Each inner-region irradiation area 334 is surrounded by an (or the) uncured partial area 324 of the adhesive layer. The uncured partial area 324 of the adhesive layer also lies between the cured marginal irradiation area 314 of the adhesive layer and the inner-region irradiation areas 334. The inner regions 33 are arranged uniformly distributed in the central region 32, 33 and in addition either periodically—as in the figure—or aperiodically (not represented).

As a result, the security element is permanently bonded to the target substrate. When using the irradiation unit 14 in FIG. 1, for example, the security element 3 is already bonded for the release of the transfer carrier 2.

The distributed arrangement with cured partial areas separated from one another leads in addition to increased manipulation protection. Removal of the security element 3 from the target substrate 1 without thereby destroying the security element 3 and/or the target substrate 1 (particularly in the case of security elements with their own carrier layer/foil) is prevented or at least made substantially more difficult.

The provision of a marginal region 31 is advantageous both for production and later for the subsequent manipulation protection. The plurality of isolated cured partial areas are surrounded by the continuous marginal irradiation area, which makes nondestructive removal even more difficult. The transparent marginal region 31 may however be omitted or, in a further variant, replaced with a partially opaque surrounding region in which the transparency regions 33 are present with a smaller spacing than in a central region (for example by a factor >=⅓ or >=¼).

Because of the small thickness of the partial layers of the security element 3, the adjacent co-irradiated portions are comparatively small (for example: 1<=marginal irradiation area/marginal region <1.05). There may be UV-scattering relief structures or scattering bodies in the transparency elements 31, 33, for example in a relief layer of the security element or in a (surface-wide) UV scattering layer of the security element, which is arranged between the UV-opaque and adhesive layers during the irradiation.

The transparent marginal region has on average a size (length or width) which lies for example between 0.2 and 1.5 mm. Security elements 3 may be arranged on the transfer carrier successively with a spacing which lies for example between 3 and 10 mm. Between the security elements 3, the transfer carrier is preferably free from the partial layers of the security element (these have already been removed before providing the transfer carrier).

The transport direction would still run from left to right. The security element 3 extends in its length from left to right in the figure. The width of the security element 3 is measured from the top downward in the figure. FIG. 2 shows a patch as a security element. A security element 3 such as a strip or patch may be present on each individual item, such as a banknote, of a target substrate, which is for example in the form of a target-substrate sheet or web in the transfer apparatus.

Since the security element is transported through the apparatus, just one irradiation unit that irradiates the width of the security element 3 is sufficient to irradiate the security element 3 fully. The irradiation unit is preferably switched on for the security element when it reaches the unit and switched off again when the security element leaves the unit. The irradiation unit is chosen so that it selectively irradiates only one security element in the transport direction (and no neighboring security elements in the transport direction).

FIG. 3 illustrates a security element 3 with the target substrate 1 in a similar representation as in FIG. 2.

A plurality of UV-transparent raster elements 34 are arranged distributed (regularly or irregularly) in the central region 32, 34 of the security element. For the observer, the security element shows the optically variable effect of the effect region when viewed directly (and/or when viewed in transmission). The raster elements 34 are not visible to the observer when viewed directly. When viewed in transmission, the raster elements 34 may be visible, in particular as shapeless points. The observer does not perceive a possible shape of the raster elements 34 even when viewed in transmission. The raster elements 34 have, for example, a round or rectangular shape. Their maximum size (such as length or width) is less than 300 μm, generally between 10 μm and 150 μm. They are generated by local removal of a UV-opaque partial layer of the security element, for example by means of etching, washing or lasering.

Optionally, the marginal region 31 may be present and/or one or more (a few, in particular from two to five) inner regions 33 may be present. The raster elements 34 are arranged uniformly distributed over the security element 3, insofar as there is locally no marginal or inner region 31, 33.

Each UV-transparent raster element 34 generates a raster-element irradiation area 344 on the adhesive layer during irradiation from the security element side (optionally through the transfer carrier). The outer boundaries 343 of the raster-element irradiation areas 344 may lie in the effect region 32. The adjacent portions that are co-irradiated through the raster elements 34 and lie in the effect region 32 form an increasing proportion of the irradiated area with a decreasing size of the raster elements. The ratio of raster-element irradiation area to raster element is greater than 1.1, and lies for example in the range of from 1.2 to 5.

The distribution of the raster elements 34 in the security element 3, or in the central region 32, 33, 34 of the security element 3, is chosen so that, during the irradiation through the raster elements 34, a plurality of raster-element irradiation areas 344, or cured partial areas of the adhesive layer, are created, these being separated from one another by at least one, in FIG. 3 precisely one, uncured partial area 324 of the adhesive layer. The marginal-region irradiation area 314 is also separated from the raster-element irradiation areas 344 by the uncured partial area 324 of the adhesive layer. There are thus a plurality of permanent bonds isolated/separated/spaced apart from one another between the security element 3 and the target substrate 1 after the irradiation.

The number of raster elements 34 is chosen so that there is also a good permanent bond in the central region. For example, between 10% and 50%, preferably from 10% to 25%, of the area of the adhesive layer may be cured in the central region (without taking inner regions into account), or in a region with raster elements. Overall, preferably at least 40%, in particular between 40% and 80%, of the area of the adhesive layer of the security element is cured. Inner regions have a size of more than 300 um in at least one direction (such as length or width), preferably in two mutually perpendicular directions (such as length and width). For example, a plurality of uncured partial areas 324 (instead of a single one) may be created by an elongate inner region 33 or a plurality of inner regions 33 lying close next to one another. Each raster-element irradiation area, however, remains surrounded by one of the uncured partial areas 324.

The plurality of inner regions 33 of FIG. 2 are replaced in the embodiment according to FIG. 3 with the plurality of raster elements 34. All further remarks already made for FIG. 2 in respect of details, variants and embodiments will not be repeated here, but are also applicable in FIG. 3.

FIG. 4 shows in cross section a security element 3 on a target substrate 1, which may correspond to each of the embodiments discussed so far but is based on the example of FIG. 3. An arrow indicates the direction of the observation and/or the irradiation.

More precisely, the figure represents an adhesive layer 7 and a partial layer 6, which is opaque to the (UV) irradiation, of the security element 3. The security element 3 comprises the already known regions 31 to 34. The security element 3 preferably shows an optically variable effect in the effect region 32, for example by means of a relief structure on which a reflecting metallic layer is arranged as a partial layer 61.

The adhesive layer 7 comprises cured portions 71, 73, 74 and a continuous uncured portion 72 or a plurality of uncured portions 72, which separates or separate the cured portions 71, 73, 74 from one another. The opaque partial layer 6 has one (or in the case of a strip precisely two) marginal recess(es) 61. The partial layer 6 is present in all portions 62. In the inner region 32, 33, 34 of the security element 3, the partial layer 61 is recessed in a plurality of raster elements 64 and in an inner region 63.

The cured portions 71, 73, 74 of the adhesive layer have been created by the irradiation of the adhesive layer through the transparency elements 31, 33, 34. The marginal recess 61, the inner recess 63 and the raster elements 64 correspondingly each lie over the cured portions 71, 73, 74, respectively. The irradiation areas of FIGS. 2 and 3 correspond to the cured portions in FIG. 4. In other regards also, to avoid repetition, reference may be made to the comments already provided above.

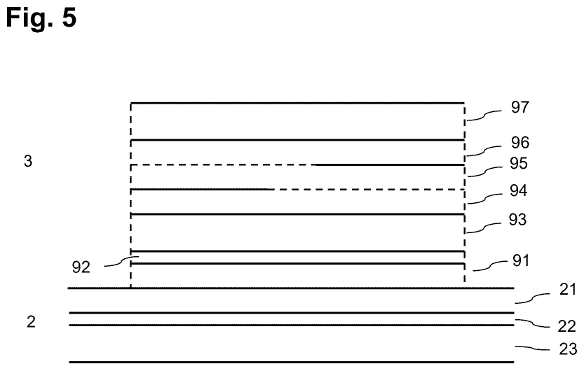

FIG. 5 shows by way of example various merely conceivable partial layers of a security element 3 on a transfer carrier 2 (in cross section). The carrier 2 itself may comprise two carrier layers 21, 23 with a lamination layer lying between them, as is already described in detail in WO 2010/031543 A1.

The security element 3 is a multilayer element. The outer shape of the security element may correspond to a first motif or a simple geometrical shape. It is preferentially an optically variable security element which comprises an optical security feature for observation in direct view and/or viewing in transmission.

The following partial layers 91 to 97 of the transfer element, some of which are optional, are represented in FIG. 5.

The optical security feature is formed by one or more partial layers 94 to 96. Particularly preferentially, the optical security feature is configured to be regionally differently structured and/or optically variable (modified impression for the observer when tilting or rotating), for example in the form of a second and/or a third motif. The optical security feature of the security element comprises an embossing-coating layer 94 into which an optically effective relief structure is embossed. Provided on the relief structure, there is a reflection-increasing partial layer 95, for example a metallization or an HRI layer. The latter may be present surface-wide, over part of the surface with the aforementioned recesses and/or partially as a rastered partial layer. On the reflection-increasing partial layer 95, there is preferentially a further ink partial layer (or functional partial layer) 96, which may be opaque or translucent and/or differently colored (pigmented) and/or optically variable (OVI pigments) or activatable (luminescent, thermochromic and/or reversibly or irreversibly variable, etc.).

The radiation-curable adhesive layer 97 relevant here is arranged above the optically effective partial layers 94 to 96, in particular as a UV-curable hot-melt coating. In the cured state, the adhesive layer ensures the permanent bond with the target substrate.

In order to assist the release of the security element 3 from the transfer carrier 2, a release partial layer 91 of the security element 3 may-as is conventional-be arranged on the surface of the transfer carrier 2. In the present case, the security element 3 could optionally comprise a further intermediate bonding layer 92.

Likewise known as an optional partial layer is a foil partial layer 93, which may serve as a supporting partial layer in the security element 3. The height of such multilayered security elements 3 typically lies between 20 and 100 μm.

1.-15. (canceled)

16. A method for transferring a security element onto a target substrate, comprising:
providing the security element;
applying the security element onto the target substrate;
irradiating a radiation-curable adhesive layer from the security element side in order to cure the radiation-curable adhesive layer, as a result of which the security element is permanently bonded to the target substrate,
wherein the security element is opaque to the irradiation in an effect region and is transparent to the irradiation in at least one transparency element;
wherein for the irradiation from the security element side, a plurality of transparency elements are arranged distributed in the security element in such a way that a plurality of cured partial areas of the adhesive layer are created during the irradiation through the transparency elements, these partial areas being separated from one another by at least one uncured partial area of the adhesive layer, and
the plurality of transparency elements comprises a plurality of transparent raster elements.

17. The method as claimed in claim 16, wherein for the observer, the transparent raster elements are not perceptible when viewed directly; and/or
are visible but do not have a perceptible shape when viewed in transmission.

18. The method as claimed in claim 16, wherein the plurality of transparency elements comprises one or more transparency regions.

19. The method as claimed in claim 16, wherein the plurality of transparency elements comprises a transparent marginal region of the security element, the security element comprising the transparent marginal region and a central region, in which the effect region and the plurality of raster elements lie.

20. The method as claimed in claim 16, wherein the security element is provided on a transfer carrier, the transfer carrier being released from the security element applied onto the target substrate, the irradiation from the security element side taking place before the release and through the transfer carrier.

21. The method as claimed in claim 16, wherein the raster elements are arranged regularly distributed, in a periodic raster, or irregularly distributed.

22. The method as claimed in claim 18, wherein the transparency regions are arranged regularly distributed, in a periodic raster, or irregularly distributed.

23. The method as claimed in claim 16, wherein the raster elements and the transparency regions are surrounded by the effect region.

24. The method as claimed in claim 18, wherein the transparency region or regions is/are in a shape that is perceptible for the observer when viewed directly and/or when viewed in transmission; wherein, there are in the security element transparency regions
with a first shape and at least one second shape; or
with a uniform shape.

25. The method as claimed in claim 16, wherein
the radiation-curable adhesive layer is a UV-curing adhesive layer and the irradiation takes place by UV light; and/or
the transfer carrier comprises a multiplicity of security elements, separated from one another and are arranged successively and/or next to one another on the transfer carrier; and/or
the security element is a transfer patch or a transfer strip; and/or the security element is an optically variable security element, optically variable as a function of the observation angle; and/or
the security element has an opaque effect layer, including a reflecting metal layer or an ink layer, and/or an embossed relief layer, in the effect region.

26. The method as claimed in claim 16, wherein the adhesive layer is irradiated in more than 20% but less than 80% of its area, in a central region comprising more than 10% but less than 50% of its area; and/or
the area of the security element corresponds to the area of the effect region together with the area of the transparency elements; and/or
the adhesive layer has an irradiation area, which consists of an optional marginal irradiation area and respectively either a plurality of raster-element irradiation areas, optionally with one or a few transparency-region irradiation areas, or a plurality of transparency-region irradiation areas.

27. The method as claimed in claim 16, wherein the radiation-curable adhesive layer
is provided as a layer of the security element, and/or is an adhesive layer that is cured by UV light, or by shortwave light <450 nm, and/or
is a thermally activatable, radiation-curable adhesive layer, including a hot-melt adhesive layer, a UV-curing hot-melt adhesive layer.

28. A transfer carrier having security elements, wherein
the security elements are arranged releasably on the transfer carrier and, for transfer onto a target substrate, by a method as claimed in claim 16, comprise an adhesive layer which can be cured with curing radiation;
the transfer carrier is transparent to the curing radiation;
the security elements respectively have an effect region which is opaque to the curing radiation and at least one transparency element which is transparent to the curing radiation;
wherein for irradiation from the security element side, a plurality of transparency elements are arranged distributed in the security element in such a way that a plurality of cured partial areas of the adhesive layer are created during the irradiation through the transparency elements, these partial areas being separated from one another by at least one uncured partial area of the adhesive layer, and
the plurality of transparency elements comprises a plurality of transparent raster elements.

29. A system for carrying out a method as claimed in claim 27, comprising the transfer carrier and a transfer apparatus,
wherein a plurality of security elements are arranged on the transfer carrier, and wherein
the security elements are arranged successively in the transport direction, and/or the security elements are arranged separated from one another and spaced apart from one another, and/or
the security elements are in the form of a patch or strip, with or without their own carrier layer.

30. A target substrate having a security element, produced according to or having the features of claim 16, wherein the security element is fastened on the target substrate by an adhesive layer,
wherein the adhesive layer is formed from radiation-curable material and comprises at least one cured portion and one uncured portion,
wherein the security element has an effect region which is opaque to curing radiation of the radiation-curable material and at least one transparency element which is transparent to the curing radiation,
wherein a plurality of transparency elements, which respectively lie over a cured portion of the adhesive layer, are arranged in the security element, and
the cured portions of the adhesive layer are separated from one another by at least one uncured portion of the adhesive layer, and
the plurality of transparency elements comprise a plurality of transparent raster elements.
